(19) United States
(12) Patent Application Publication
(10) Pub. No.: US 2010/0321190 A1
(43) Pub. Date: Dec. 23, 2010

(54) TEMPERATURE SENSITIVE UNIT

(76) Inventor: Nicholas Patrick Montague, Norfolk (GB)

Correspondence Address: KNOBBE MARTENS OLSON & BEAR LLP, 2040 MAIN STREET, FOURTEENTH FLOOR, IRVINE, CA, 92614, US

(21) Appl. No.: 12/528,291

(22) PCT Filed: Feb. 21, 2008
(86) PCT No.: PCT/GB2008/000618

§ 371 Date: Aug. 21, 2009

(30) Foreign Application Priority Data
Feb. 21, 2007 (GB) 0703316.0

(51) Int. Cl. G08B 17/00

(52) U.S. Cl. 340/584

(57) ABSTRACT

A temperature sensitive unit comprises a temperature sensor, a recording medium for recording a signal representative of the occurrence of a temperature breaching a predetermined level, a switch for interrogating said recording medium, a signal generator which is configured to produce an audible and/or visual signal dependent upon the recording of an occurrence of a temperature breach, and one or more powering means for driving said sensor and said generator.

### FIELD OF THE INVENTION

The invention relates to temperature sensitive units.

### BACKGROUND OF THE INVENTION AND PRIOR ART KNOWN TO THE APPLICANT

In molecular biology a box containing temperature sensitive enzymes may be damaged if they are left out of a freezer environment for too long. This is a relatively common error which can lead to reactants rendered useless or less effective. This may have important financial consequences and in worst cases wipe out months of valuable research.

A single storage container, commonly containing up to 50 tubes, may contain thousands of pounds worth of biological agents. The contents of each single tube could be worth several hundreds of pounds. For example the “BigDye terminator” routinely used for the sequencing of DNA in all fields of molecular biology, in medical research and diagnostics, and by the Police, costs around £300 per 100 μl and is highly temperature sensitive.

The following prior art documents are acknowledged: U.S. Pat. No. 6,226,997B1, JP6347339, FR2729221, WO02/048663, GB1285674, GB2205427, JP57037228, U.S. Pat. No. 6,226,997, WO02/026386, WO2006/130760, and WO2003/087784.

### SUMMARY OF THE INVENTION

In a first broad independent aspect, the invention provides a temperature sensitive unit, comprising a temperature sensor, a recording medium for recording a signal representative of the occurrence of a temperature breaching a predetermined level, a switch for interrogating said recording medium, a signal generator which is configured to produce an audible and/or visual signal dependent upon the recording of an occurrence of a temperature breach, and one or more powering means for driving said sensor and said generator.

In a subsidiary aspect, the invention further comprises a casing which encloses said temperature sensor, said signal generator, said powering means; wherein the unit further comprises at least a portion shaped and configured for the insertion into a cavity of a microbiological tray of tubes such as Eppendorf tubes or the like.

In a further subsidiary aspect, said temperature sensitive unit further comprises a cap in which the electronic components of said unit are located; said electronic components consist of a temperature sensor, a recording medium for recording the occurrence of a temperature breaching a predetermined level, a switch for interrogating said recording medium, and a signal generator which is configured to produce an audible and/or visual signal dependent upon the recording of an occurrence of a temperature breach, one or more powering means for driving said sensor and said generator, one or more circuit boards, electronic circuitry for communication between the preceding components, and a supporting means for supporting said components within said cap.

In a further subsidiary aspect, supporting means incorporates two circuit boards located on either side of said powering means.

In a further subsidiary aspect, said unit incorporates a cap which fully encloses said temperature sensitive unit.

In a further subsidiary aspect, said cap incorporates a relatively rigid wall and a relatively flexible wall located over said switch to allow a user to manually interact with said switch by depressing said flexible wall.

In a further subsidiary aspect, said temperature sensor incorporates a probe which is attached to or forms a projecting member.

In a further subsidiary aspect, the unit incorporates a casing which has a section with a diameter of 10 millimetres or less.

In a further subsidiary aspect, the unit incorporates no interface with an external data processor.

In a further subsidiary aspect, the unit incorporates a port for attachment to an external data processor which is encapsulated into a casing.

In a further subsidiary aspect, the unit incorporates a casing which entirely encapsulates the temperature sensor, the signal generator and the powering means.

In a further subsidiary aspect, said signal generator is a piezoelectric sounder.

In a further subsidiary aspect, the unit further comprises a voltage reference chip; wherein said voltage reference chip and said temperature sensor are adapted to only switch on when a temperature reading is required.

In a further subsidiary aspect, means are provided to switch on said chip and said sensor prior to taking a reading for a period which is sufficient for stabilization of the chip to occur.

In a further subsidiary aspect, said signal generator is configured to produce a first kind of alarm signal when the temperature rises from a first temperature level to a second temperature level and a second kind of alarm signal when the temperature rises to a third temperature level.

In a further subsidiary aspect, said signal generator is configured to produce a first kind of alarm signal when the temperature is below a first temperature level; a second kind of alarm signal when the temperature is between a first temperature level and a second temperature level; and a third kind of alarm signal when the temperature rises above said second temperature level.

In a further subsidiary aspect, the unit further comprises a memory for storing a signal representative of the temperature value.

In a further subsidiary aspect, the unit is adapted to ensure that no alarm is triggered during a monitoring period and that an alarm is triggered only after the monitoring period by a user triggering a switch which if a breach of temperature was identified during the monitoring period an alarm would only then be triggered.

In a further subsidiary aspect, the unit further comprises a memory for storing a signal representative of the number of times the unit has been above a predetermined temperature level.

In a further subsidiary aspect, the unit incorporates a trigger for the activation and deactivation of the unit between a standby mode and a temperature sensing mode.

In a further subsidiary aspect, the unit incorporates a trigger which when actuated by an operator triggers the production of an alarm.

In a further subsidiary aspect, the unit incorporates a trigger which is located within a casing which is sufficiently flexible; whereby when pressure is applied onto the casing it deforms sufficiently to actuate the trigger.

In a further subsidiary aspect, means are provided to record peak temperatures.

In a further subsidiary aspect, said powering means comprises a silver oxide cell.

In a further subsidiary aspect, the unit incorporates a trigger for triggering the interrogation of the unit; the generator produces a first kind of signal if no alarm signal has been generated since the last interrogation or a second kind of signal if an alarm signal has been generated since the last interrogation.

In a further subsidiary aspect, the unit stores no signals representing specific temperature and time data other than the occurrence of the generation of a signal.

In a second broad independent aspect, the invention provides a container cap incorporating a temperature sensor, a signal generator which produces an alarm signal if the temperature breaches a predetermined level and a power source for driving both said sensor and said generator.

In a third broad independent aspect, the invention provides a temperature sensitive unit, comprising a casing, a temperature sensor, a signal generator which produces an alarm signal if the temperature breaches a predetermined level, and a power source for driving both said sensor and said generator; characterised in that the unit stores no specific temperature and time data other than the occurrence of the generation of a signal during an operation period of said unit.

In a fourth broad independent aspect, the invention provides a biological reagent tube cap, comprising a temperature sensitive unit according to the first aspect.

In a subsidiary aspect, said temperature sensitive unit is located within the walls of said cap and consists of a temperature sensor, a recording medium for recording the occurrence of a temperature breaching a predetermined level, a switch for interrogating said recording medium, and a signal generator which is configured to produce an audible and/or visual signal dependent upon the recording of an occurrence of a temperature breach, one or more powering means for driving said sensor and said generator, one or more circuit boards, electronic circuitry for communication between the preceding components, a supporting means for supporting said components within said cap.

In a subsidiary aspect, said supporting means incorporates two circuit boards located on either side of said powering means.

In a subsidiary aspect, said cap fully encloses said temperature sensitive unit.

In a further subsidiary aspect, said cap incorporates a relatively rigid wall and a relatively flexible wall located over said switch to allow a user to manually interact with said switch by depressing said flexible wall.

In a fifth broad independent aspect, a bag suitable for containing blood or the like, incorporates a recessed portion sized and shaped to receive a temperature sensitive unit according to any of the preceding aspects; wherein said recessed portion incorporates an opening allowing the insertion and removal of said unit.

In a sixth broad independent aspect, the invention provides a temperature sensitive unit, comprising a casing, a temperature sensor, a signal generator which produces an alarm signal if the temperature breeches a pre-determined level and a power source for driving both said sensor and said generator, characterised in that the unit further comprises at least a portion shaped and configured for the insertion into a cavity of a microbiological tray or tubes such as Eppendorf tubes or the like.

This configuration marks a complete departure from the developing art which seeks to incorporate an ever increasing number of functions into sensors for triggering a remote alarm. It allows the unit to accompany the sensitive material which requires to be monitored.

In a subsidiary aspect in accordance with the invention's sixth broad independent aspect, the casing has a section with a diameter of 10 mm or less. This allows the ready insertion and removal of the unit from a cavity in a microbiological tray.

In a further subsidiary aspect, the casing houses no interface with an external data processor. This allows the indication of temperature to be generated only by the unit in order to allow the monitoring to occur at the particular location of the unit.

In a further subsidiary aspect, the temperature sensor, the signal generator and the power source are each entirely located within said casing. These sensitive components can therefore be protected by the casing in order to function in a wide range of applications. It also allows them to be located in close proximity from one another which allows them to be of greater compactness than the prior art units.

In a further subsidiary aspect, said generator is a piezoelectric sounder. This minimises the power consumption required for the generation of an alarm whilst allowing an alarm to be generated from the unit. It further improves the compactness of the overall unit.

In a further subsidiary aspect, a voltage reference chip is provided wherein said voltage reference chip and said temperature sensor are only switched on when a temperature reading is required. This allows the unit to operate for an extended period of time for at least two years in most cases. It may be possible for the unit to operate for a period of 10-15 years.

In a further subsidiary aspect, means are provided to switch on said chip and said sensor prior to taking a reading for a period which is sufficient for stabilisation of the chip to occur. This configuration ensures error free temperature reading signals to be obtained.

In a further subsidiary aspect, said signal generator produces a first kind of alarm signal when the temperature rises from a first temperature level to a second temperature level and a second kind of alarm signal when the temperature rises to a third temperature level. This allows the operator to gain a sufficiently precise understanding of temperature fluctuations without the use of LCD screens and other high power consumption devices.

In a further subsidiary aspect, said signal generator produces a first kind of alarm signal when the temperature is below a first temperature level; a second kind of alarm signal when the temperature is between a first temperature level and a second temperature level; and a third kind of alarm signal when the temperature rises above said second temperature level. This also allows a detailed assessment of the temperature fluctuations to occur without recourse to high power consumption devices.

In a further subsidiary aspect, the unit comprises a memory for storing a signal representative of the temperature value.

In a further subsidiary aspect, the unit further comprises a memory for storing the number of times the unit has been above a predetermined temperature level. This allows the user to assess the likelihood of damage which the temperature sensitive goods monitored may have incurred.

In a further subsidiary aspect, the unit incorporates a trigger for the activation and deactivation of the unit between a standby mode and a temperature sensing mode. This configuration also further minimises the power source required for the operation of the unit.

In a further subsidiary aspect, the unit incorporates a trigger which when actuated by an operator triggers the production of an alarm. This system may delay the production of the alarm in order to further economise on the power consumed.

In a further subsidiary aspect, the unit incorporates a trigger which is located within a casing which is sufficiently flexible; whereby when pressure is applied onto the casing it deforms sufficiently to actuate the trigger. This configuration is particularly advantageous because it allows the components of the unit to be fully encased or at least prevent there being an opening between the casing and a button.

In a further subsidiary aspect, means are provided to record the peak temperatures. In one embodiment recording peak temperatures only produces the storage facility required and therefore minimises the size of the components and their power consumption.

In a further subsidiary aspect, said power source comprises a silver oxide cell. This allows the unit to operate over a period of at least two years whilst being able to fit within the confined spaces which the invention contemplates.

In a further subsidiary aspect, the unit incorporates a trigger for triggering the integration of the unit; the generator produces a first kind of signal if no alarm signal has been generated since the last interrogation or a second kind of signal if an alarm signal has been generated since the last interrogation. This also allows the unit to communicate with an operator whilst avoiding draining the power source which could occur if an alarm signal sounds continuously since the breach of temperature.

In a further subsidiary aspect, the unit stores no signals representing specific temperature and time data other than the occurrence of the generation of a signal.

In a seventh broad independent aspect, the invention provides a container cap incorporating a temperature sensor, a signal generator which produces an alarm signal if the temperature breaches a pre-determined level and a power source for driving both said sensor and said generator. This would allow an operator to avoid accidentally leaving out a product contained by the container. This would lend itself ideally to mass production since the components are reduced to a minimum.

In an eighth independent aspect, the invention provides a temperature sensitive unit, comprising a casing, a temperature sensor, a signal generator which produces an alarm signal if the temperature breaches a pre-determined level, and a power source for driving both said sensor and said generator; characterised in that the unit stores no specific temperature and time data other than the occurrence of the generation of a signal during an operation period of said unit. This would allow an operator to assess whether the goods with which the unit is employed have or have not deteriorated having experienced an alarm situation. It also avoids undue power consumption if the alarm continuously sounds since the occurrence of an original signal.

### BRIEF DESCRIPTION OF THE FIGURES

FIG. 1 shows a temperature sensitive unit in cross section in accordance with a first embodiment of the invention where a push-button protrudes from a casing.

FIG. 2 shows a cross sectional view of the temperature sensitive unit with a casing which is entirely closed around the circuit.

FIG. 3 shows a circuit diagram in a further embodiment of the invention.

FIG. 4 shows a part cross sectional view of a temperature sensitive unit with a flexible lid.

FIG. 5 shows a schematic view of a sensor in accordance with a further embodiment of the invention.

FIG. 6 shows a cross-sectional view of a cap incorporating a temperature sensitive unit.

FIG. 7 shows a plan view of a disc-shaped circuit board.

FIGS. 8A and B show respectively a cap with a sensor probe with a cap incorporated into a tube.

FIGS. 9A and B show respectively a blood bag prior to insertion of a temperature sensor and the combination of a blood bag and a temperature sensor.

### DETAILED DESCRIPTION OF THE FIGURES

FIG. 1 shows a temperature sensitive unit generally referenced 1 with a casing 2 enclosing a circuit 3. The circuit may be of the kind described below. A button 4 protrudes from a side of the casing. A spring for example a helicoidal coil 5 attaches the extremity 6 of button 4 to the casing's inside wall.

The casing is generally cylindrical in shape with rounded upper and lower regions. In an alternative embodiment, the lower region of the casing may have a square edge for stability.

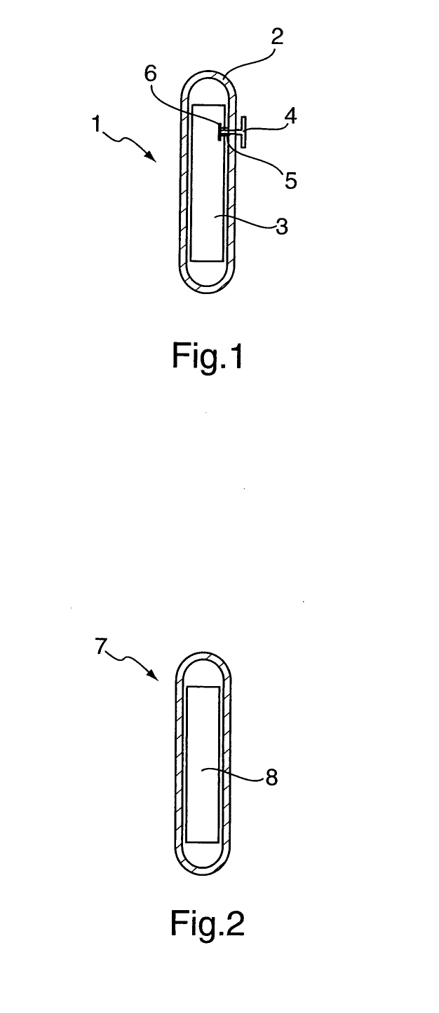

FIG. 2 shows a further embodiment with a temperature sensitive unit 7 and a circuit 8.

The wall of the casing may be flexible for example by employing a flexible plastic material. The flexible wall of the casing may be deformed inwardly by an operator. A trigger may be located spaced from the inside of the wall of the casing prior to the wall being flexed and when flexed the wall causes the displacement of the trigger to initiate a mode of operation of the unit.

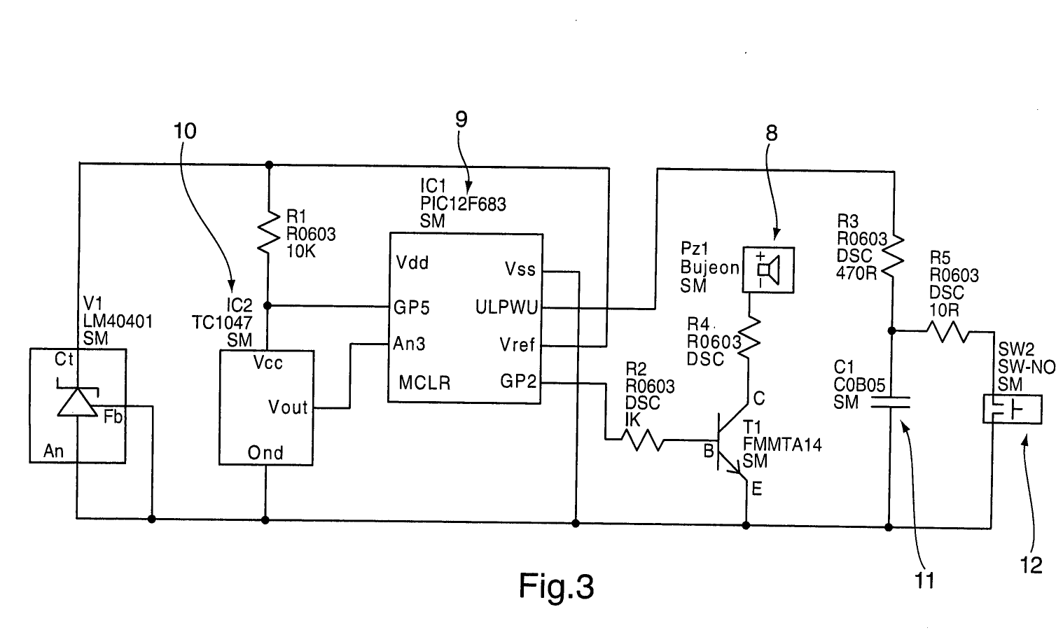

The circuit as shown in FIG. 3 incorporates an audible alarm which is triggered in the event of the sensed temperature exceeding a pre-programmed value. Piezoelectric sounder 8 is provided which may be a 3 volts/3 kHz piezoelectric sounder. The current used in driving the piezoelectric sounder may be in the order of 20/30 mA.

The circuit incorporates a microprocessor 9 which is preferably an IC1 microprocessor available from Microchip. The microcontroller has preferably inbuilt non-volatile memory which is used to store details of which state the unit is currently in either standby or temperature monitoring. In one embodiment of the microcontroller it may be programmed prior to placing on the board. It is possible that the chip is programmed then re-taped for the placement machine. The microprocessor allows the temperature value and alarm regime to be configured for deferring applications. The power is preferably supplied by two silver oxide batteries placed in series in order to provide a 65 mAh 3V power source which allows the microcontroller to operate with its required 3V. Alternatively, a lithium cell may be employed. The combination of circuit and battery can operate within a confined space of for example 10 mm in diameter or less the circuit may be on a printed circuit board (PCB) which is 21 mm in length with a lower section being 7 mm wide and 12 mm long and the upper section being 9 mm square. These dimensions do not include the battery or batteries.

In one mode of operation, the circuit operates in a low power mode. In this mode, the circuit is in standby mode. The power consumption is less than 250 mA. In one embodiment the system never switches off completely in order to either be in a standby mode or in a second mode of operation which is a temperature monitoring mode. In order to economise power, the temperature sensor generally referenced 10 and the voltage reference chip or chips are only switched on when a temperature reading is required and a small time delay has been implemented to allow for the stabilisation of the chips.

Since the system allows for a customer to specify an alarm regime this will ultimately determine the overall life expectancy of the device. This circuit allows for diverse modes of operation, the device may be fully programmed at the point of manufacture. The chip is able to be pre-programmed. The alarm may be activated in a number of ways not just set to pre-set temperatures. The device may be configured to remember or to store signals representative of how many alarm cycles have occurred whilst in an over-temperature state and then give a sequence of sounds to indicate the length of time it had been in an over-temperate state. The device may be programmed to store signals representative of some of the temperature history. It may also have a number of pre-programmed modes of operation which may be controlled dependent upon a method of turning on the device by for example configuring the circuit to respond differently to a single or a double click. It will then be able for example to set an alarm at a different pre-determined temperature.

In one preferred mode of operation, the circuit activates every minute or so which allows the circuit to operate for a period of up to 10-15 years.

The overall length of the unit may be limited to 45 mm with a width of 10 mm. In a further embodiment a top region of the unit has a section with a diameter of 20 mm contrasting with a lower portion of the unit with a diameter of 10 mm.

A capacitor C1 generally referenced 11 controls the timing of the automated cyclic wake up of the unit. As an alternative to the automatic cyclic waking up of the unit, the circuit may be adapted to be triggered manually by the operation of the push-button generally referenced 12.

The unit lends itself to shipping in the standby mode of operation. In this mode, the unit wakes up every minute or so and checks to see if the push-button has been pressed. If the button has not been pressed it then checks if it is in standby mode and it goes back to steep until the next automated wake up call. If the system finds that the wake up has been caused by the push-button it takes a temperature reading and then reports the temperature to the user by means of several beeps. Once this operation has been completed the system checks to see if the push-button is still pressed and if it is the system then changes into temperature monitoring mode and signals to the user by sounding a switch on message. In a similar fashion, the unit can be switched off by holding the push-button down when in the temperature monitoring mode.

In the temperature monitoring mode, the unit wakes up and checks the temperature. If it is above the set value it can be programmed to trigger an audible alarm, store the value in a memory or log the number of times that the system has been above temperature. The unit may be programmed to capture multiple temperature points. It may also simply record the highest and lowest temperatures. In one embodiment of the invention, the unit employs two temperature set points to allow a basic division of temperatures into cold, warm or hot categories. The cold category is any temperature sensed below the low temperature set point. The warm category is any temperature sensed between the two temperature set points. The high category is for any temperature sensed above the high temperature set point. The unit may be configured to respond when the user-presses the button by issuing a message. The message may be configured as a three part message. The first part of such a message provides the current temperature (one beep for cold, two beeps for warm and three beeps for hot). The second part of the message indicates the highest recorded temperature (one, two, or three beeps). The third part of the message indicates the number of times the temperature had been logged for being at the highest recorded temperature. The log may include a maximum of ten times. The system may be configured so that the action of pressing the button may also reset the log back to zero.

The following components are used in the example of a circuit as shown in FIG. 3:

| | | |
|---|---|---|
| R1 | 10K | 0603 1% OR 5% |
| R2 | 1K | 0603 1% OR 5% |
| R3 | 470R | 0603 1% OR 5% |
| R4 | 0R | 0603 1% OR 5% |
| R5 | 10R | 0603 1% OR 5% |
| C1 | 1 μF | X5R 0805 (Value is used to select wake up |
| | | delay) |
| IC1 | PIC12F683 | Microprocessor |
| IC2 | TC1047 | Temperature sensor |
| IC3 | LM4041 | Precision voltage reference |
| T1 | FMMTA14 | npn transistor |
| PZ1 | | 3 V 3 kHz piezo sounder |
| SW2 | SDS001 | n/o momentary switch |
| Batteries | V393 | 1.5 V 65 mAh (two required) |

The resistors may be either 1% or 5% precision. R4 may be shorted out but may be implemented dependent upon the final choice of piezoelectric sounder.

C1 determines the wakeup timing of the whole system. Using a 0805 ceramic capacitor allows values up to 100 pF to be specified. This provides for wakeup times ranging from seconds to minutes to be specified by changing the value of this component. These capacitors are available from multiple sources such as AVX.

IC1 is available from Microchip.

IC2 is supplied by Microchip and is adapted to operate as a precision temperature sensor.

IC3 is a precision voltage reference IC. Texas Instruments may supply this product.

T1 is a standard npn transistor and is used to drive the sounder.

PZ1 is a 3V piezoelectric sounder. This piezoelectric sounder may be obtained from Bujeon, or Sonicrest. The system may be configured to run at 3 kHz.

The switch is an open momentary contact switch of the ITT SDSOO1 type.

The batteries may be supplied by Varta V393. Their diameter may be 7.9 mm with a capacity of 65 mAh.

The circuit board may be supplied in a panellised form with around 100 boards per panel.

The unit may be programmed to for example sound an alarm when the temperature rises from minus 20 degrees Celsius to minus 5 degrees Celsius by showing a double beep. Simultaneously, the unit may be programmed to issue a long sound in response to changes when the temperature rises to plus 10 degrees Celsius. In order to distinguish the alarm sounds this may be beeps of higher frequency. It may also be a triple beep.

When removing the unit from a freezer a status report in the form of a succession of beeps may be generated. On pressing a button on the unit a single beep indicates that the temperature is within the correct range, then another beep indicates that the device has been within the correct temperature parameters since last checked. A double beep could indicates that an over temperature event has occurred. A subsequent series of beeps can indicate for how many hours the device had been in the over-temperature state. The device may take the form of a sticky patch to attach to Eppendorf boxes which are required to contain a full complement of 50 tubes all built into the box itself.

The unit may incorporate instead of or as well as the sounder a lighting means such as a red or green LED to act as an indicator of over temperature conditions. This may have particular applications when transporting temperature sensitive goods.

A further embodiment of the invention envisages employing the circuit in a moulded plastic screw cap which may be used on medicine bottles containing temperature sensitive medicines.

A further embodiment envisages the use of a radio frequency transmitting device from the unit to an alarm. It would preferably be an unpowered device with the capacity of storing 2000 bits of information.

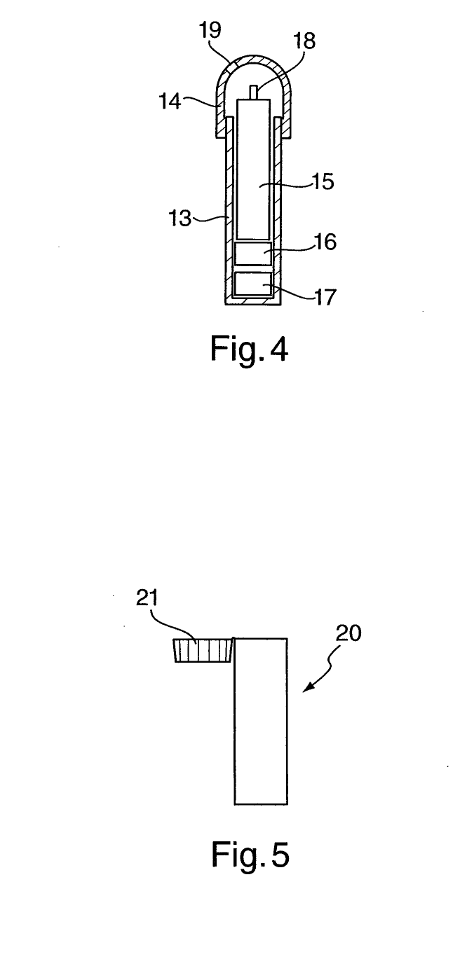

FIG. 4 shows an Eppendorf tube 13 which comprises a separable lid 14. The tube is of a relatively rigid plastics material whilst the lid is of a relatively flexible plastics material. The temperature sensor is located within the tube and employs a circuit on a printed circuit board 15. The circuit board is powered by two button type batteries located in the lower most portion of the tube. The batteries are referenced respectively 16 and 17. A metallic clip (not shown) may be employed to create an electrical contact between the circuit and the batteries. The button for triggering the operation of the sensor is located at the upper most portion of the circuit board and is generally referenced 18. The lid is of flexible plastics material to allow an operator to sufficiently bend the wall of the lid in order to actuate the button 18. The operation of the button has been described in previous embodiments in detail. It may be used for switching the device on and off and for interrogating the device. One or more apertures are provided in the lid such as aperture 19. The invention also envisages that the aperture may be in the tube wall instead of or in addition to the aperture in the lid. In order to protect the printed circuit board it is envisaged that it may be potted.

The tube 13 may be a standard Eppendorf tube whose original lid has been severed and replaced by the lid shown in FIG. 4. It may also be an Eppendorf tube which has a threaded engagement with a lid.

The circuit may incorporate a passive RF tag which allows information to be written to the processing means of the circuit. It may also allow information to be downloaded from the processing means. A scanner or other similar device may be provided.

FIG. 5 shows a tube 20 with a hinged lid 21 which may comprise a compartment into which a substance with an appropriate melting point may be placed and if the tube is placed in an environment with a temperature which is above the melting point of the substance when the lid is closed the liquid would then run into the tube to indicate that temperature conditions have been breached. Whilst this embodiment shows the compartment in the lid it may also be located in another appropriate part of the tube. The liquid used may also be appropriately coloured in order for any previous melting to be immediately spotted upon inspection by an operator.

In a further embodiment the temperature sensor electronics may be placed in the cap of a container. A trigger may be placed in either the container or the cap which detects when the container has been opened and initiates an electric timer. This would allow for example to track how long it has been since the container (for example a medicine bottle) has been opened. It would allow the user to keep within the recommended “use by 6 months after opening” time period. The electronics may be adjusted for any suitable time period dependent upon the particular label. An alarm, for example in the form of a visual alarm such as a red LED visible on the cap surface would then be able to alert the user that the used-by time has expired. The timer may be triggered for example by a pressure sensor monitoring the change in pressure within the bottle on opening or by the mechanical action of opening.

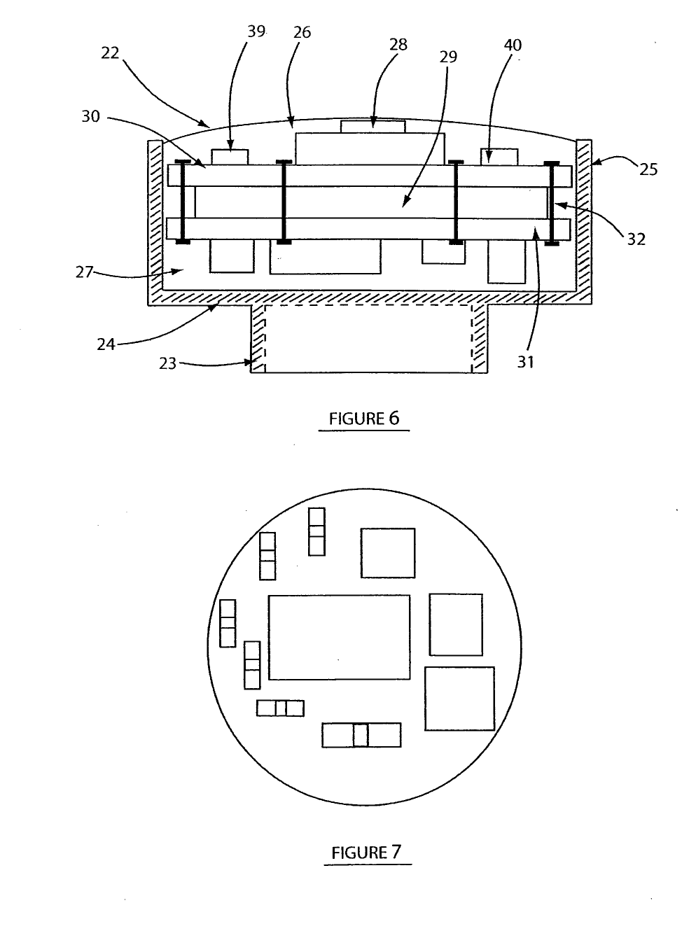

FIG. 6 shows a cap generally referenced 22 suitable for attachment to an Eppendorf tube. Sleeve 23 is sized and shaped to fit tightly on the inside wall of the upper portion of a tube. The tube abuts against flange 24. The upper portion of cap 22 incorporates a relatively rigid wall 25 which in conjunction with a domed shaped upper cover 26 entirely encloses the temperature sensitive unit generally referenced 27. Immediately beneath the flexible cover 26 is provided a push switch 28 which triggers the interrogation of the recording medium or processor part of the unit. The electrical components may be of the kind described in detail in FIG. 3 which in this configuration may be disposed either side of battery 29. Battery 29 is sandwiched between an upper disc-shaped circuit board 30 and a lower disc-shaped circuit board 31. A number of connectors 32 which may be made of copper material extend between the upper and lower disc-shaped circuit boards.

In an alternative embodiment, the circuit board layers may be located above the battery rather than in the sandwiching configuration outlined above. FIG. 7 shows the disc-shaped circuit board 31 from beneath.

In a preferred embodiment, a single battery is employed instead of a plurality of individual batteries.

In a further embodiment, the circuitry is disposed on a thin, foldable printed circuit board in order to allow it to fit in the cap.

In addition, in an embodiment of the invention, the printed circuit boards are populated on both sides with the necessary components.

The caps for the tubes may either incorporate a tether or not. Alternatively, the caps may be screw threaded onto a corresponding tube.

The amount of power of the battery may be selected to allow operation of several hours instead of several days dependent upon the shipping duration of the products it accompanies.

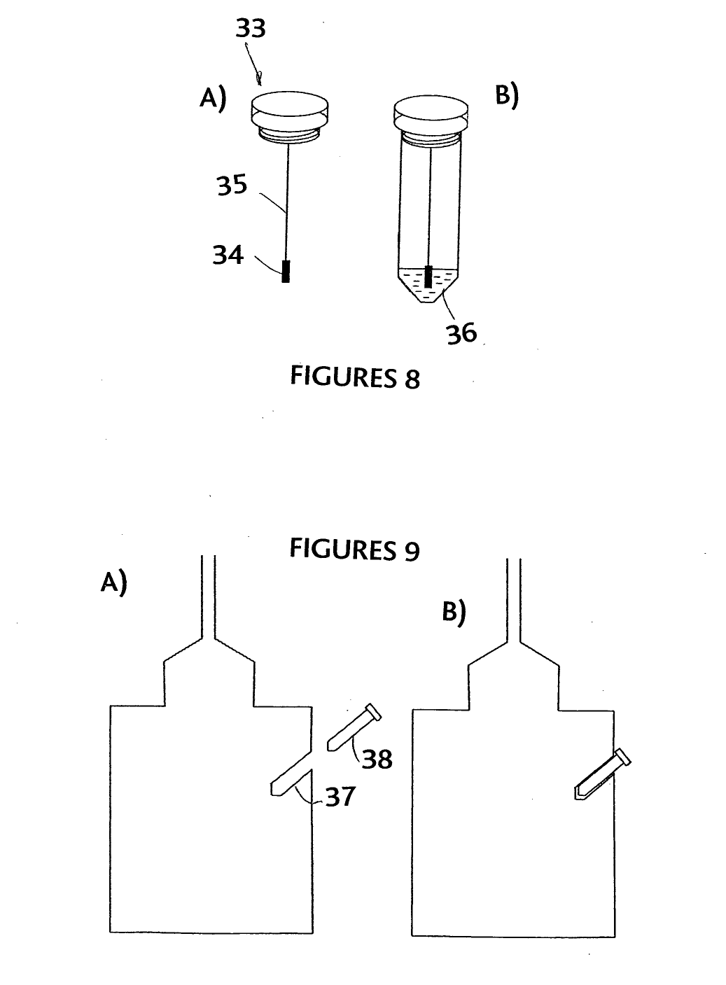

FIG. 8 show an embodiment of a cap 33 in which a temperature sensitive unit is provided. Cap 33 further incorporates a temperature sensor probe 34 which may be located at the end of a projecting member 35. The projecting member 35 may be extendable in length dependent upon the usage envisaged. As shown in FIG. 8B, the probe dips into a biological liquid 36. In an alternative embodiment, the probe may be located within the wall of a tube or secured adjacent to the wall with at its upper extremity forming a contact point which engages the cap of the tube in order to establish a contact for communicating signals to the unit located in the cap. In a further embodiment, the probe may be a wireless temperature probe located in or adjacent to the wall at a lower extremity of the tube and a wireless communication link would be provided between the probe and the circuitry located in the cap.

FIGS. 9A and B show schematic cross-sectional views of blood bags. The blood bag may also be suitable for housing other kinds of liquids such as plasma. The wall of the bag incorporates a recessed portion 37 into which a temperature sensor 38 may be located. As shown in FIG. 9B, the recessed portion may be moulded as part of the wall of the bag. The combination of a blood bag and a temperature sensor would allow the temperature to be accurately monitored. The individual packaged product could be programmed to indicate if a temperature situation had occurred and the duration of that situation. For instance, if that product is compromised if exceeding 10° centigrade (either in one instance or cumulatively) the device could be programmed to indicate whether this situation had occurred (by, say, a red light).

As shown in FIG. 6 a light emitting diode (LED) 39 may be provided which would be of a red colour to indicate whether a situation of over exposure had occurred. Alternatively, if the temperature conditions have been within the acceptable ranges, a second LED 40 may be illuminated which would be of a green colour or other appropriately contrasting colour.

The invention envisages in one embodiment only incorporating a single LED or visual indicator acting as an alarm rather than any other forms of alarm such as a piezoelectric sounder.

Alternatively, the invention envisages incorporating a single audible alarm without any other form of alarm.

Instead of employing the flexible membrane or flexible cover 26, it is envisaged that a rigid cover may be employed as long as it is displaceable against an enclosed push switch. It may for example be possible to have a rigid cover attached to a rigid cap wall via a flexible seal; whereby a pressure applied on the rigid cover would cause the rigid cover to displace against the push switch.

In a further embodiment, a port may be provided for connection to a processor. In this configuration, the circuitry is envisaged as fully encapsulated within a casing so that access to the port is only possible by breaking the cap or casing open. This would prevent the user tampering with the temperature sensor. In a further embodiment, the circuitry may incorporate a wireless link so that historical data logged by the recording medium may be downloaded to appropriate processing means. A wireless link may also be provided and adapted for receiving remote control instructions in order to set the mode of operation of a given temperature sensor.

1-35. (canceled)

36. A temperature sensitive unit comprising a temperature sensor, a recording medium for recording a signal representative of the occurrence of a temperature breaching a predetermined level, a switch for interrogating said recording medium, a signal generator which is configured to produce one at least of an audible and a visual signal dependent upon the recording of an occurrence of a temperature breach, and at least a power source for driving said sensor and said generator.

37. A unit according to claim 1, comprising a casing which encloses said temperature sensor, said signal generator, and said power source; wherein the unit further comprises at least a portion shaped and configured for the insertion into a cavity of a microbiological tray of tubes which are selected from the group comprising: Eppendorf tubes, biological content tubes, and like tubes.

38. A unit according to claim 1, wherein said temperature sensitive unit further comprises a cap housing electronic components; said electronic components consist of a temperature sensor, a recording medium for recording the occurrence of a temperature breaching a predetermined level, a switch for interrogating said recording medium, and a signal generator which is configured to produce one at least of an audible and visual signal dependent upon the recording of an occurrence of a temperature breach, at least one power source for driving said sensor and said generator, one or more circuit boards, electronic circuitry for communication between the preceding components, and a support for supporting said components within said cap.

39. A unit according to claim 2, wherein said temperature sensitive unit further comprises a cap housing electronic components; said electronic components consist of a temperature sensor, a recording medium for recording the occurrence of a temperature breaching a predetermined level, a switch for interrogating said recording medium, and a signal generator which is configured to produce one at least of an audible and visual Signal dependent upon the recording of an occurrence of a temperature breach, at least one power source for driving said sensor and said generator, one or more circuit boards, electronic circuitry for communication between the preceding components, and a support for supporting said components within said cap.

40. A unit according to claim 2, wherein a support incorporates two circuit boards located on either side of said power source.

41. A unit according to claim 1, wherein said unit incorporates a cap which fully encloses said temperature sensitive unit.

42. A unit according to claim 6, wherein said cap incorporates a relatively rigid wall and a relatively flexible wall located over said switch to allow a user to manually interact with said switch by depressing said flexible wall.

43. A unit according to claim 1, wherein said temperature sensor incorporates a probe with a projecting member.

44. A unit according to claim 1, wherein the unit incorporates a casing which has a section with a diameter of 10 millimeters or less.

45. A unit according to claim 1, wherein the unit incorporates no interface with an external data processor.

46. A unit according to claim 1, wherein the unit incorporates a port for attachment to an external data processor which is encapsulated into a casing.

47. A unit according to claim 1, wherein the unit incorporates a casing which entirely encapsulates the temperature sensor, the signal generator and the power source.

48. A unit according to claim 1, wherein said signal generator is a piezoelectric sounder.

49. A unit according to claim 1, further comprising a voltage reference chip; wherein said voltage reference chip and said temperature sensor are adapted to only switch on when a temperature reading is required.

50. A unit according to claim 14, wherein a controller is provided to switch on said chip and said sensor prior to taking a reading for a period which is sufficient for stabilization of the chip to occur.

51. A unit according to claim 1, wherein said signal generator is configured to produce a first kind of alarm Signal when the temperature rises from a first temperature level to a second temperature level and a second kind of alarm signal when the temperature rises to a third temperature level.

52. A unit according to claim 1, wherein said signal generator is configured to produce a first kind of alarm signal when the temperature is below a first temperature level; a second kind of alarm signal when the temperature is between a first temperature level and a second temperature level; and a third kind of alarm signal when the temperature rises above said second temperature level.

53. A unit according to claim 1, further comprising a memory for storing a signal representative of the temperature value.

54. A unit according to claim 1, further comprising a memory for storing a signal representative of the number of times the unit has been above a predetermined temperature level.

55. A unit according to claim 1, wherein the unit incorporates a trigger for the activation and deactivation of the unit between a standby mode and a temperature sensing mode.

56. A unit according to claim 1, wherein the unit incorporates a trigger which when actuated by an operator triggers the production of an alarm.

57. A unit according to claim 1, wherein the unit incorporates a trigger which is located within a casing which is sufficiently flexible; whereby when pressure is applied onto the casing it deforms sufficiently to actuate the trigger.

58. A unit according to claim 1, wherein a memory is provided to record peak temperatures.

59. A unit according to claim 1, wherein said power source comprises a silver oxide cell.

60. A unit according to claim 1, wherein the unit incorporates a trigger for triggering the interrogation of the unit; the generator produces a first kind of signal if no alarm signal has been generated since the last interrogation or a second kind of signal if an alarm signal has been generated since the last interrogation.

61. A unit according to claim 1, wherein the unit stores no signals representing specific temperature and time data other than the occurrence of the generation of a signal.

62. A container cap incorporating a temperature sensor, a signal generator which produces an alarm signal if the temperature breaches a predetermined level and a power source for driving both said sensor and said generator.

63. A temperature sensitive unit, comprising a casing, a temperature sensor, a signal generator which produces an alarm signal if the temperature breaches a predetermined level, and a power source for driving both said sensor and said generator; wherein the unit stores no specific temperature and time data other than the occurrence of the generation of a signal during an operation period of said unit.

64. A biological reagent tube cap, comprising a temperature sensitive unit according to claim 1.

65. A biological reagent tube cap according to claim 29, wherein said cap incorporates walls; said temperature sensitive unit being located within the walls of said cap and consisting of a temperature sensor, a recording medium for recording the occurrence of a temperature breaching a predetermined level, a switch for interrogating said recording medium, and a signal generator which is configured to produce one at least of an audible and visual signal dependent upon the recording of an occurrence of a temperature breach, at least one power source for driving said sensor and said generator, at least one circuit board, electronic circuitry for communication between the preceding components, and a support for supporting said components within said cap.

66. A cap according to claim 30, wherein said support incorporates two circuit boards located on either side of said power source.

67. A cap according to claim 30, wherein said cap fully encloses said temperature sensitive unit.

68. A cap according to claim 30, wherein said cap incorporates a relatively rigid wall and a relatively flexible wall located over said switch to allow a user to manually interact with said switch by depressing said flexible wall.

69. A bag suitable for containing blood or the like, incorporating a recessed portion sized and shaped to receive a temperature sensitive unit according to claim 1; wherein said recessed portion incorporates an opening allowing the insertion and removal of said unit.

70. A temperature sensitive unit, comprising a casing, a temperature sensor, a signal generator which produces an alarm signal if the temperature breaches a predetermined level, and a power source for driving both said sensor and said generator, wherein the unit further comprises at least a portion shaped and configured for the insertion into a cavity of a microbiological tray of tubes which are selected from the group comprising Eppendorf tubes, biological content tubes, and like tubes.
